(19) United States
(12) Patent Application Publication
(10) Pub. No.: US 2025/0022072 A1
(43) Pub. Date: Jan. 16, 2025

(54) INFORMATION PROVISION APPARATUS, INFORMATION PROVISION METHOD, AND NON-TRANSITORY STORAGE MEDIUM

(71) Applicant: NEC Corporation, Minato-ku, Tokyo (JP)

(72) Inventors: Kazufumi KOJIMA, Tokyo (JP); Massahiro TANI, Tokyo (JP); Keisuke IKEDA, Tokyo (JP)

(73) Assignee: NEC Corporation, Minato-ku, Tokyo (JP)

(21) Appl. No.: 18/713,285

(22) PCT Filed: Dec. 6, 2021
(86) PCT No.: PCT/JP2021/044705

§ 371 Date: May 24, 2024

(51) Int. Cl. G06Q 50/00

(52) U.S. Cl. CPC G06Q 50/01

(57) ABSTRACT

The present invention provides an information provision apparatus including an acquisition unit that acquires public information associated with each of a plurality of accounts existing in each of a plurality of types of social networking services (SNSes), a connection determination unit that determines a connection between a plurality of the accounts, based on the public information, a same-user-owned account determination unit that determines, based on the public information, a plurality of the accounts owned by a same user, and a visualization unit that collectively displays, as information indicating a connection of a certain user on an SNS, a connection between each of a plurality of the accounts owned by the certain user and another of the accounts.

### TECHNICAL FIELD

The present invention relates to an information provision apparatus, an information provision method, and a program.

### BACKGROUND ART

Techniques related to the present invention are disclosed in Patent Documents 1 to 4 and Non-Patent Documents 1 to 8.

Patent Document 1, Non-Patent Documents 1 to 4, and Non-Patent Document 8 each disclose a technique for estimating, based on a friendship and the like, an activity range of a user who has an account on a social networking service (SNS).

Patent Documents 2 to 4, and Non-Patent Documents 5 and 6 each disclose a technique for determining an account of an SNS owned by the same user.

Patent Document 5 discloses a technique for determining a position of a user when text data or the like are posted to an SNS.

Non-Patent Document 7 discloses a technique for visualizing a connection between accounts on one specific SNS with a plurality of nodes and a line connecting the nodes.

### RELATED DOCUMENT

### Patent Document

Patent Document 1: International Patent Publication No. WO2021/028988
Patent Document 2: International Patent Publication No. WO2019/187107
Patent Document 3: International Patent Publication No. WO2019/234827
Patent Document 4: Japanese Patent Application Publication No. 2013-122630
Patent Document 5: Japanese Patent Application Publication No. 2018-010378

### Non-Patent Document

Non-Patent Document 1: “Study of residential area estimation method focusing on geographical proximity of friend groups” written by Keisuke Ikeda, Kazufumi Kojima, Masahiro Tani, The Institute of Electronics, Information and Communication Engineers, IEICE Technical Report, Vol. 119, No. 317, pp. 37 to 42, AI2019-36, November, 2019
Non-Patent Document 2: “Graph-based residence location inference for social media users” written by Dan Xu, Peng Cui, Wenwu Zhu, Shiqiang Yang, IEEE Computer Society, IEEE MultiMedia, Volume 21, Issue 4, pp. 76 to 83, October, 2014
Non-Patent Document 3: “Find me if you can: Improving geographical prediction with social and spatial proximity” written by Backstrom Lars, Eric Sun, Cameron Marlow, Proceedings of the 19^{th} international conference on World Wide Web, 2010, pp. 61 to 70
Non-Patent Document 4: “Closeness and structure of friends help to estimate user locations” written by Liu Zhi, Yan Huang, International Conference on Database Systems for Advanced Applications, Springer, pp. 33 to 48
Non-Patent Document 5: Y. Li, Y. Peng, W. Ji, Z. Zhang, and Q. Xu, “User Identification Based on Display Names Across Online Social Networks”, IEEE Access, vol. 5, pp. 17342 to 17353, Aug. 25, 2017
Non-Patent Document 6: X. Han, X Liang and et al. “Linking social network accounts by modeling user spatiotemporal habits”, Intelligence and Security Informatics (ISI), IEEE International Conference on, 2017
Non-Patent Document 7: “whotwi is a twitter analysis tool: Usage and function are analyzed!”, [online], One Million Labo Keywords only, [searched on Nov. 10, 2021], Internet
Non-Patent Document 8: “Social media user's location estimation method based on Kernel Density Estimation” written by Keisuke Ikeda, Kazufumi Kojima, Masahiro Tani, The Institute of Electronics, Information and Communication Engineers, IEICE Technical Report, Vol. 120, No. 379, pp. 18 to 23, A12020-42, February, 2021

### DISCLOSURE OF THE INVENTION

### Technical Problem

In recent years, many users own accounts of a plurality of SNSes.

Moreover, there is a user who owns a plurality of accounts on one SNS. A technique described in Non-Patent Document 7 merely displays a connection between one account owned by a certain user on one specific SNS and another account. When the user owns a plurality of accounts, display of a technique described in Non-Patent Document 7 merely displays a part of a connection between the user and another user formed by the plurality of accounts.

An object of the present invention is to provide a technique for recognizing a connection between users on an SNS in more detail.

### Solution to Problem

The present invention provides an information provision apparatus including:
an acquisition unit that acquires public information associated with each of a plurality of accounts existing in each of a plurality of types of SNSes;
a connection determination unit that determines a connection between a plurality of the accounts, based on the public information;
a same-user-owned account determination unit that determines, based on the public information, a plurality of the accounts owned by a same user; and
a visualization unit that collectively displays, as information indicating a connection of a certain user on an SNS, a connection between each of a plurality of the accounts owned by the certain user and another of the accounts.

Moreover, the present invention provides an information provision method including, by a computer executing:
an acquisition step of acquiring public information associated with each of a plurality of accounts existing in each of a plurality of types of SNSes;
a connection determination step of determining a connection between a plurality of the accounts, based on the public information;
a same-user-owned account determination step of determining, based on the public information, a plurality of the accounts owned by a same user; and
a visualization step of collectively displaying, as information indicating a connection of a certain user on an SNS, a connection between each of a plurality of the accounts owned by the certain user and another of the accounts.

Moreover, the present invention provides a program causing a computer to function as:
an acquisition unit that acquires public information associated with each of a plurality of accounts existing in each of a plurality of types of SNSes;
a connection determination unit that determines a connection between a plurality of the accounts, based on the public information;
a same-user-owned account determination unit that determines, based on the public information, a plurality of the accounts owned by a same user; and
a visualization unit that collectively displays, as information indicating a connection of a certain user on an SNS, a connection between each of a plurality of the accounts owned by the certain user and another of the accounts.

### Advantageous Effects of Invention

According to the present invention, it becomes possible to recognize a connection between users on an SNS in more detail.

### BRIEF DESCRIPTION OF THE DRAWINGS

FIG. 1 It is a diagram illustrating one example of a hardware configuration of an information provision apparatus according to the present example embodiment.

FIG. 2 It is one example of a functional block diagram of the information provision apparatus according to the present example embodiment.

FIG. 3 It is a diagram schematically illustrating one example of information that the information provision apparatus according to the present example embodiment processes.

FIG. 4 It is a diagram schematically illustrating one example of information that the information provision apparatus according to the present example embodiment processes.

FIG. 5 It is a flowchart illustrating one example of a flow of processing of the information provision apparatus according to the present example embodiment.

FIG. 6 It is a diagram schematically illustrating one example of a screen that the information provision apparatus according to the present example embodiment displays.

FIG. 7 It is one example of a functional block diagram of the information provision apparatus according to the present example embodiment.

FIG. 8 It is a diagram schematically illustrating one example of a screen that the information provision apparatus according to the present example embodiment displays.

FIG. 9 It is a diagram schematically illustrating one example of a screen that the information provision apparatus according to the present example embodiment displays.

FIG. 10 It is a diagram schematically illustrating one example of a screen that the information provision apparatus according to the present example embodiment displays.

FIG. 11 It is one example of a functional block diagram of the information provision apparatus according to the present example embodiment.

FIG. 12 It is a diagram schematically illustrating one example of a screen that the information provision apparatus according to the present example embodiment displays.

FIG. 13 It is a diagram schematically illustrating one example of a screen that the information provision apparatus according to the present example embodiment displays.

FIG. 14 It is one example of a functional block diagram of the information provision apparatus according to the present example embodiment.

FIG. 15 It is a diagram schematically illustrating one example of a screen that the information provision apparatus according to the present example embodiment displays.

FIG. 16 It is a diagram schematically illustrating one example of a screen that the information provision apparatus according to the present example embodiment displays.

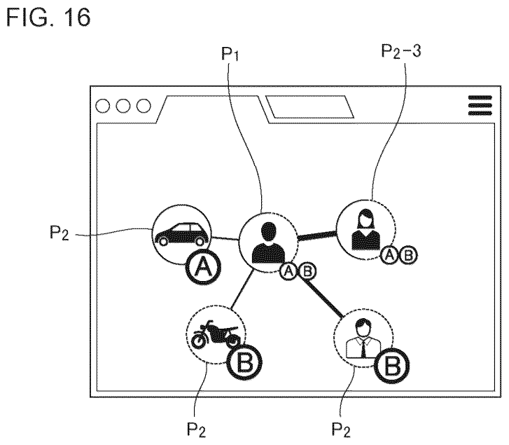

### DESCRIPTION OF EMBODIMENTS

Hereinafter, an example embodiment of the present invention is described by use of the drawings. Note that, in all of the drawings, a similar component is assigned with a similar reference sign, and description thereof is omitted as appropriate.

### First Example Embodiment

### “Outline”

An information provision apparatus according to the present example embodiment acquires public information associated with each of a plurality of accounts of a plurality of users existing in each of a plurality of types of SNSes. Subsequently, the information provision apparatus determines a connection between a plurality of accounts, based on the acquired public information. Moreover, the information provision apparatus determines, based on the acquired public information, a plurality of accounts owned by the same user. Then, the information provision apparatus collectively displays, as information indicating a connection of a certain user on an SNS, a connection between each of a plurality of accounts owned by the user and another account.

According to such an information provision apparatus according to the present example embodiment, it becomes possible to recognize a connection between a user and another user on an SNS in more detail.

### “Hardware Configuration”

Next, one example of a hardware configuration of the information provision apparatus is described. Each functional unit of the information provision apparatus is achieved by any combination of hardware and software mainly including a central processing unit (CPU) of any computer, a memory, a program loaded onto the memory, a storage unit such as a hard disk that stores the program (that can store not only a program stored in advance from a phase of shipping an apparatus but also a program downloaded from a storage medium such as a (compact disc) CD or a server or the like on the Internet), and an interface for network connection. Then, it is appreciated by a person skilled in the art that there are a variety of modified examples of a method and an apparatus for the achievement.

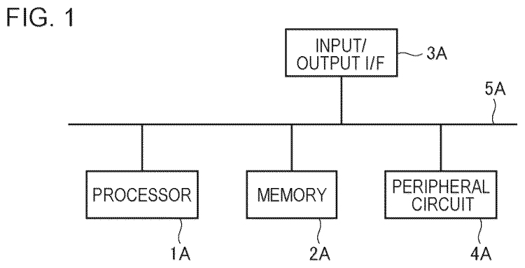

FIG. 1 is a block diagram illustrating a hardware configuration of the information provision apparatus. As illustrated in FIG. 1, the information provision apparatus includes a processor 1A, a memory 2A, an input/output interface 3A, a peripheral circuit 4A, and a bus 5A. The peripheral circuit 4A includes various modules. The information provision apparatus may not include the peripheral circuit 4A. Note that, the information provision apparatus may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### “Function Configuration”

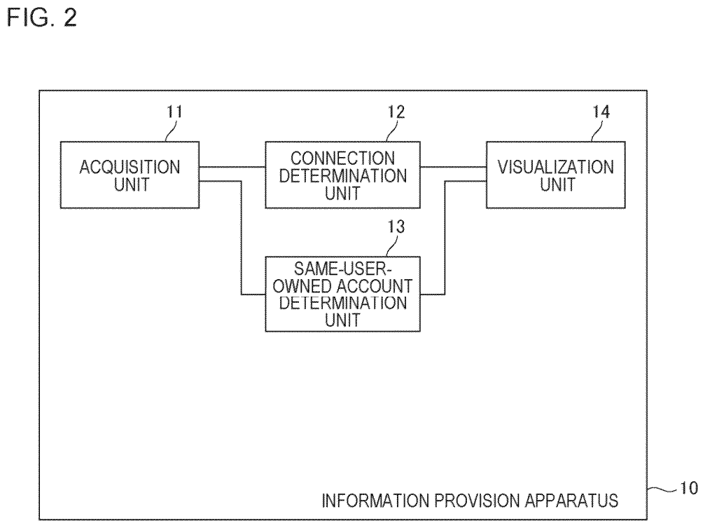

Next, a functional configuration of the information provision apparatus is described. FIG. 2 illustrates one example of a functional block diagram of an information provision apparatus 10. As illustrated, the information provision apparatus 10 includes an acquisition unit 11, a connection determination unit 12, a same-user-owned account determination unit 13, and a visualization unit 14.

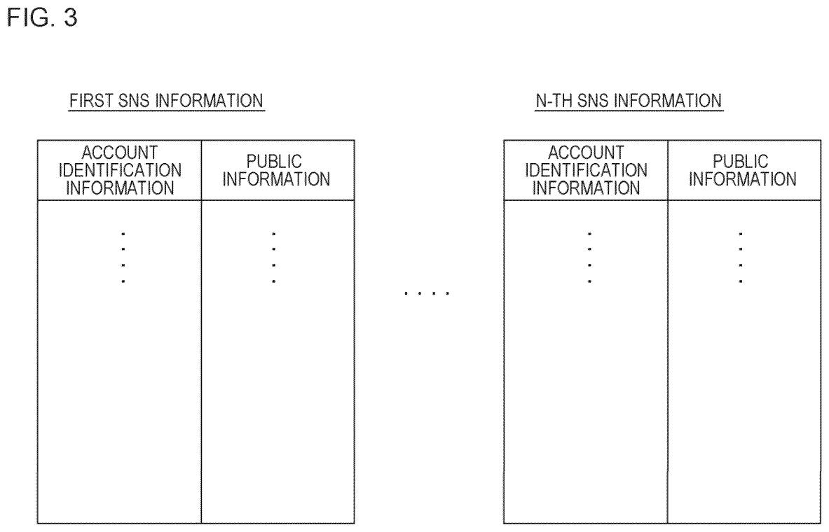

The acquisition unit 11 acquires public information associated with each of a plurality of accounts of a plurality of users existing in each of a plurality of types of SNSes. The acquisition unit 11 acquires public information in association with account identification information from each of various SNS servers. The acquisition unit 11 causes a storage unit of the information provision apparatus 10 to store the acquired information. FIG. 3 schematically illustrates one example of information acquired by the acquisition unit 11 and stored in the storage unit. In the illustrated example, a large number of pairs of account identification information and public information are stored for each SNS.

The “account identification information” is information that identifies a plurality of accounts from each other.

The “public information” can include any information published on an SNS in association with each account. For example, public information includes at least one of a profile of a user of each account, a posted matter posted by a user of each account, relationship information indicating a relationship with a user of another account on an SNS, a profile of a user of another account having a predetermined relationship with a user of each account on an SNS, and a posted matter posted by the user of the another account.

An item included in the “profile” may be different for each SNS, but may include, for example, a user name, a nickname, a gender, a date of birth, a nationality, an age (or a generation), a place of birth, a current place of residence, an affiliation (a company name, a school name), a school attended, and the like.

The “posted matter” is a message, a still image, a moving image, a sound, or a content resulting from a combination of these, or the like.

The “relationship information” is information indicating a connection with another account on an SNS. For example, relationship information may indicate at least one of another school attended having a mutually following relationship with each account, another account followed by each account, another account following each account, and another account having an exchange history of a message with each account.

Returning to FIG. 2, the connection determination unit 12 determines a connection between a plurality of accounts, based on the public information acquired by the acquisition unit 11. The connection determination unit 12 determines, for each SNS, a connection between a plurality of accounts existing on each SNS.

“Another account having a connection with a certain account” is at least one of, for example, an account having a mutually following relationship with a certain account, an account followed by a certain account, an account followed by a certain account, an account having an exchange history of a message with a certain account, and an account of a user who has been in the same place at the same timing as a user of a certain account. Note that, exemplification herein is one example, and the present invention is not limited thereto.

“Having an exchange history of a message” may be a state where at least one of users has sent text data, an emoji, a photograph, a video, a sound, an icon, or the like to another user, or has taken action by pressing a like button. Otherwise, “having an exchange history of a message” may be a state where both users have sent, to each other, text data, an emoji, a photograph, a video, a sound, an icon, or the like, or have taken action by pressing a like button.

“A user who has been in the same place at the same timing as a user of a certain account” may be determined, for example, based on a posting place and a posting date and time. When a difference of posting dates and times is within a criterion value and posting places are the same or a difference thereof is within a criterion value between postings of a user of a certain account and a user of another account, the two users may be determined to be in the same place at the same timing. Otherwise, when a position of a user of each account is tracked by a global positioning system (GPS), two users whose mutual distance has become within a threshold value, or two users for whom a state where mutual distance is within a threshold value has continued for equal to or more than a predetermined time may be determined to be in the same place at the same timing. Otherwise, when a facility (a shop or the like) utilized by each user and a date and time of the utilization can be acquired, two users who utilize the same facility and whose difference of utilization dates and times is within a threshold value may be determined to be in the same place at the same timing. A facility (a shop or the like) utilized by each user and a date and time of the utilization may be determined based on a posted matter of each user, or may be determined by another method.

The same-user-owned account determination unit 13 determines a plurality of accounts owned by the same user, based on public information acquired by the acquisition unit 11. A means for achieving the processing by the same-user-owned account determination unit 13 is not particularly limited.

For example, it may be achieved by use of techniques disclosed in Patent Documents 2 to 4, Non-Patent Documents 5 and 6, and the like.

The visualization unit 14 collectively displays, as information indicating a connection of a certain user on an SNS, a connection between each of a plurality of accounts owned by the user and another account. For example, when a certain user owns first to third accounts (three accounts in total), the visualization unit 14 collectively displays, as information indicating a connection of the user on an SNS, a connection between the first account and another account, a connection between a second account and another account, and a connection between the third account and another account. Note that, the visualization unit 14 displays information indicating a connection of a certain user on an SNS via an output apparatus included in the information provision apparatus 10, or an external apparatus that communicates with the information provision apparatus 10.

For example, the visualization unit 14 may input information indicating a connection of a certain user on an SNS to an output apparatus included in the information provision apparatus 10, and display the information via the output apparatus included in the information provision apparatus 10. In this case, a user input specifying a certain user is accepted via an input apparatus included in the information provision apparatus 10. The output apparatus is exemplified by, but not limited to, a display, a projection apparatus, a mailer, a printer, or the like. The input apparatus is exemplified by, but not limited to, a keyboard, a touch panel, a microphone, a physical button, a mouse, a gesture input apparatus, or the like.

Otherwise, the information provision apparatus 10 may be a server.

Then, the visualization unit 14 may transmit information indicating a connection of a certain user on an SNS to the client terminal, and display the information via the client terminal. In this case, a user input specifying a certain user is accepted via the input apparatus provided in the client terminal. The client terminal is exemplified by, but not limited to, a smartphone, a tablet terminal, a personal computer, a mobile phone, a smart watch, a television with an Internet connection function, and the like.

For example, the visualization unit 14 may output information indicating a connection of a certain user on the SNS with a plurality of nodes and a line connecting the nodes. This example is described in detail in following example embodiment.

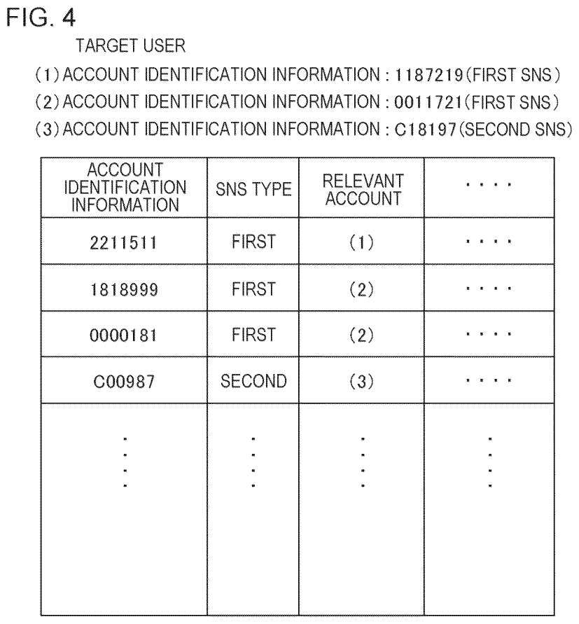

Otherwise, as illustrated in FIG. 4, the visualization unit 14 may display, as information indicating a connection of a certain user on an SNS, a list of accounts having a connection with each of a plurality of accounts owned by the user.

The information in FIG. 4 indicates a connection of a certain user (hereinafter, may be referred to as a “target user”) on an SNS. First, in an upper part of the figure, account identification information of each of three accounts owned by the target user is displayed. Then, an SNS in which each account exists is indicated in association with each of three pieces of account identification information (one of the first and second SNSes in a case of the figure). Note that, although the target user is assumed to own three accounts herein, this is only one example, and the number of accounts owned may vary from user to user.

In the information in FIG. 4, a list of accounts having a connection with each of a plurality of accounts owned by the target user is further displayed. In list display, columns for account identification information, an SNS type, and a relevant account are provided.

The column for account identification information indicates account identification information of an account having a connection with each of a plurality of accounts owned by a target user.

The column for an SNS type indicates an SNS in which each account exists (one of the first and second SNSes in a case of the figure).

The column for a relevant account indicates information indicating which of a plurality of accounts owned by the target user has a connection. In the figure, a number in parentheses displayed in the column is relevant to a number in parentheses associated with each of the three accounts owned by a target user.

For example, an account of account identification information “2211511” is an account existing in the first SNS, and indicates having a connection with an account of account identification information “1187219” of a target user.

Note that, another piece of information may be further displayed in the list display.

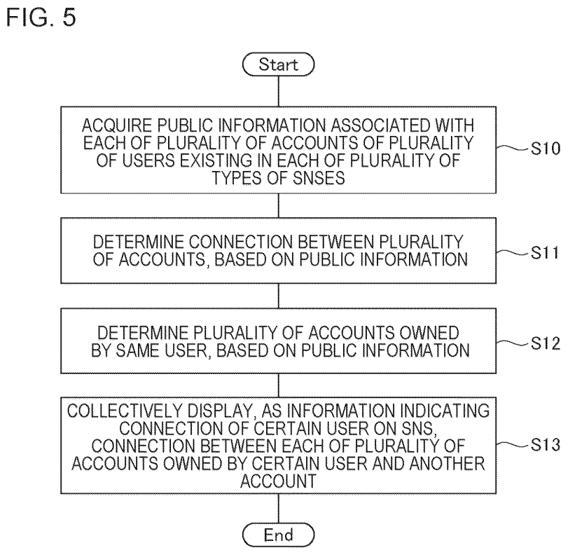

Next, one example of a flow of processing of the information provision apparatus 10 is described by use of a flowchart of FIG. 5.

First, the information provision apparatus 10 acquires public information associated with each of a plurality of accounts of a plurality of users existing in each of a plurality of types of SNSes (S10).

Next, the information provision apparatus 10 determines a connection between a plurality of accounts, based on the public information acquired in S10 (S11). Moreover, the information provision apparatus 10 determines a plurality of accounts owned by the same user, based on the public information acquired in S10 (S12). A processing order of S11 and S12 may be an order illustrated in FIG. 5 or may be reversed, or processing may be performed in parallel.

Thereafter, the information provision apparatus 10 collectively displays, as information indicating a connection of a target user on an SNS, a connection between each of a plurality of accounts owned by the user and another account (S13).

### Advantageous Effect

The information provision apparatus 10 according to the present example embodiment can collectively display, as information indicating a connection of a certain user on an SNS, a connection between each of a plurality of accounts owned by the user in one or a plurality of SNSes and another account. As a result, compared to a conventional technique that shows only a connection between one account and another account on one SNS, it becomes possible to recognize a connection between the user and another user on an SNS in more detail.

### Second Example Embodiment

An information provision apparatus 10 according to the present example embodiment outputs information indicating a connection of a target user on an SNS, with a plurality of nodes and a line connecting the nodes. A detailed description is given below.

A visualization unit 14 displays, as information indicating a connection of a target user on an SNS, a screen showing a node relevant to each of a plurality of accounts, and a line connecting the nodes of accounts having a mutual connection. Then, the visualization unit 14 displays, on the screen, one node relevantly to a plurality of accounts owned by the same user. In other words, the visualization unit 14 integrates a plurality of nodes each being relevant to each of a plurality of accounts owned by the same user into one node.

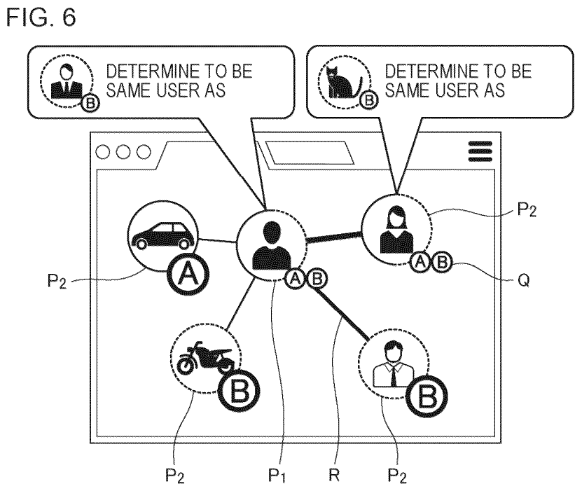

FIG. 6 illustrates one example of a screen displayed by the visualization unit 14 via an output apparatus included in the information provision apparatus 10 or a client terminal communicating with the information provision apparatus 10 (server). The screen in FIG. 6 shows a connection of a target user on an SNS. The screen displays a node P₁ relevant to the target user, and a node P₂ relevant to each account having a connection with each of a plurality of accounts owned by the target user. An icon image set on each SNS is displayed in a node. Note that, display in a node is not limited to thereto. Moreover, a line R connecting nodes relevant to accounts having a mutual connection is displayed.

Then, one node is displayed relevantly to a plurality of accounts owned by the same user. In the example of FIG. 6, the target user owns one account on each of two SNSes (owns total of two accounts), which is determined by a same-user-owned account determination unit 13. In the figure, one node P₁ relevant to two accounts owned by the target user is displayed. Moreover, when a plurality of accounts owned by a user other than the target user are determined, one node P₂ may be displayed relevantly to a plurality of accounts owned by the user. In the figure, the node P₂ displaying an icon image of a woman positioned in upper right is relevant to two accounts owned by one user.

Note that, as illustrated in FIG. 6, the visualization unit 14 may display information indicating an SNS type in which an account of each of the nodes P₁ and P₂ exists, in association with each of the nodes P₁ and P₂. An illustrated mark Q indicates the SNS type in which the account of each node P₁ and P₂ exists.

Moreover, the visualization unit 14 may change a display mode of the mark Q according to a user characteristic on each SNS. The user characteristic is exemplified by utilization frequency of each SNS (the number of postings, the number of views, the number of logins, a date and time of last login, and the like), a period of use (an elapsed time since an account formation time point), and the like. For example, a size, a color, a shape, and the like of the mark Q may be changed according to utilization frequency and a period of use.

Moreover, as illustrated in FIG. 6, the visualization unit 14 may set a type of a profile line of each of the nodes P₁ and P₂ according to an SNS type in which the account of each of the nodes P₁ and P₂ exists. In the illustrated example, profile lines of the nodes P₁ and P₂ relevant to an account of a certain SNS are solid lines, and profile lines of the nodes P₁ and P₂ relevant to an account of another SNS are dotted lines, and profile lines of the nodes P₁ and P₂ relevant to accounts of a plurality of types of SNSes are a mixture of the lines.

Other components of the information provision apparatus 10 according to the present example embodiment are similar to those according to the first example embodiment.

The information provision apparatus 10 according to the present example embodiment achieves an advantageous effect similar to that according to the first example embodiment. Moreover, the information provision apparatus 10 according to the present example embodiment can display a screen as illustrated in FIG. 6, as information indicating a connection of a certain user on an SNS. Such screen display enables intuitively recognizing a connection of a certain user on an SNS.

### Third Example Embodiment

An information provision apparatus 10 according to the present example embodiment estimates an activity area of a user of each account. Then, when information (refer to FIGS. 4 and 6) indicating a connection of a target user on an SNS is displayed, a plurality of accounts having a connection with the account of the user are grouped based on the activity area, and collectively displayed for each group. A detailed description is given below.

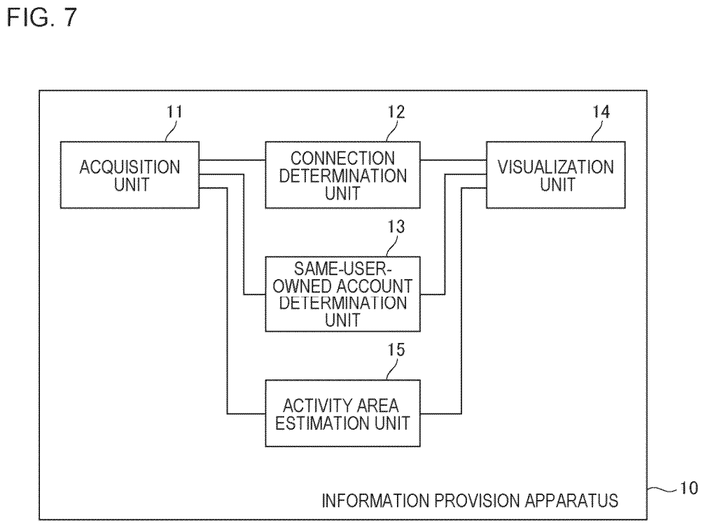

FIG. 7 illustrates one example of a functional block diagram of the information provision apparatus 10 according to the present example embodiment. As illustrated, the information provision apparatus 10 includes an acquisition unit 11, a connection determination unit 12, a same-user-owned account determination unit 13, a visualization unit 14, and an activity area estimation unit 15.

The activity area estimation unit 15 estimates an activity area of a user of each account, based on public information acquired by the acquisition unit 11.

An “activity area” is an area where a user of an account acts in a real world, and is indicated by a municipality, an area larger than that, or an area smaller than that. How to estimate an activity area of a user of each account is not particularly limited, and any technique such as techniques disclosed in Patent Document 1, Non-Patent Documents 1 to 4, and Non-Patent Document 8 can be adopted.

When displaying information (refer to FIGS. 4 and 6) indicating a connection of a target user on an SNS, the visualization unit 14 groups, based on an activity area, a plurality of accounts having a connection with an account of the target user, and collectively displays the account for each group.

In grouping, those whose activity areas are close are put together.

Criteria of grouping are varied. For example, those whose continents where activity areas are positioned correspond may be put together. Otherwise, those whose countries where activity areas are positioned correspond may be put together. Otherwise, those whose eight districts (Kanto, Kansai, and the like) where activity areas are positioned correspond may be put together. Otherwise, those whose prefectures where activity areas are positioned correspond may be put together. Otherwise, those whose municipalities where activity areas are positioned correspond may be put together. Otherwise, those whose states where activity areas are positioned correspond may be put together. The user may be able to set granularity of grouping.

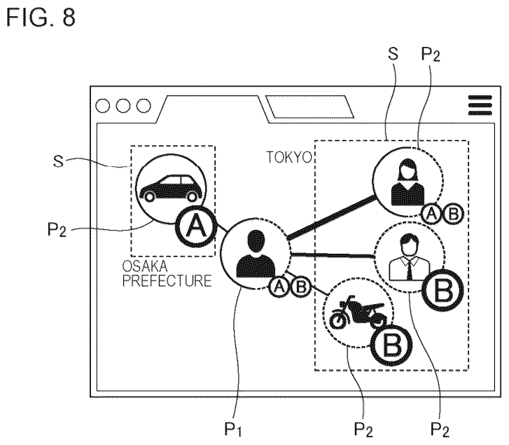

FIG. 8 schematically illustrates one example of information displayed by the visualization unit 14 via an output apparatus included in the information provision apparatus 10 or a client terminal communicating with the information provision apparatus 10 (server). In FIG. 8, a node P₂ relevant to an account having a connection with a target user (a user relevant to a node P₁) is grouped based on an activity area, and collectively displayed for each group. In FIG. 8, those whose prefectures where activity areas are positioned correspond are collectively displayed together (displayed within the same frame S).

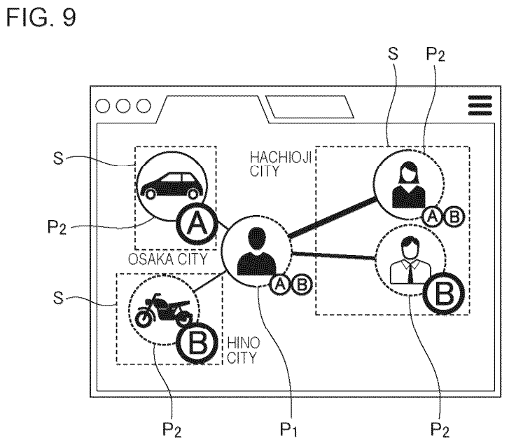

FIG. 9 schematically illustrates another example of information displayed by the visualization unit 14 via the output apparatus included in the information provision apparatus 10 or the client terminal communicating with the information provision apparatus 10 (server). Compared to the example illustrated in FIG. 8, granularity of grouping is different. Those whose prefectures where activity areas are positioned correspond are collectively displayed together (displayed within the same frame S) in the example of FIG. 8, but in the example of FIG. 9, those whose municipalities where activity areas are positioned correspond are collectively displayed together (displayed within the same frame S).

Comparing FIGS. 8 and 9, it can be seen that a result of grouping can be different when granularity of grouping is different.

For example, in a state where the screens illustrated in FIGS. 8 and 9 are displayed, the information provision apparatus 10 may accept a user input of changing granularity of grouping. Then, the information provision apparatus 10 may switch display of the screen according to a change in granularity of grouping.

Note that, when information indicating a connection of a target user on an SNS is list-displayed as illustrated in FIG. 4, a plurality of accounts belonging to the same group may be displayed in a lump in the list display. That is to say, a display form may be such that first to N₁-th rows of a table display information of an account belonging to a first group, and N₁-th to N₂-th rows display information of an account belonging to a second group.

Other components of the information provision apparatus 10 according to the present example embodiment are similar to those according to the first and second example embodiments.

The information provision apparatus 10 according to the present example embodiment achieves an advantageous effect similar to those according to the first and second example embodiment. Moreover, the information provision apparatus 10 according to the present example embodiment can recognize, in information indicating a connection of a certain user on an SNS, users of a plurality of accounts having a connection with the user, by classifying the users, based on an activity area. As a result, a connection of a certain user on an SNS can be intuitively recognized.

### Fourth Example Embodiment

An information provision apparatus 10 according to the present example embodiment displays, on a map, information in which nodes P₁ and P₂ and a line R as illustrated in FIG. 6 are positioned, as information indicating a connection of a target user on an SNS. Then, the information provision apparatus 10 positions each of the nodes P₁ and P₂ relevant to each account on an activity area of a user of each account. A detailed description is given below.

One example of a functional block diagram of the information provision apparatus 10 according to the present example embodiment is illustrated in FIG. 7.

A visualization unit 14 displays, on a map, information in which the nodes P₁ and P₂ and the line R as illustrated in FIG. 6 are positioned, as information (refer to FIG. 6) indicating a connection of a target user on an SNS. Then, the visualization unit 14 positions the nodes P₁ and P₂ relevant to each account on an activity area of a user of each account. That is to say, the visualization unit 14 displays, as information indicating a connection of a target user on a SNS, a screen in which the nodes P₁ and P₂ are displayed on a map, and in which the nodes P₁ and P₂ are displayed at positions on the map relevant to an activity area. A node P₂ relevant to an account of a user whose activity area is estimated to be Tokyo is displayed above Tokyo within the map.

Other components of the information provision apparatus 10 according to the present example embodiment are similar to those according to the first and second example embodiments.

The information provision apparatus 10 according to the present example embodiment achieves an advantageous effect similar to those according to the first and second example embodiment. Moreover, the information provision apparatus 10 according to the present example embodiment can intuitively recognize an activity area of a user of each account in information indicating a connection of a certain user on an SNS. As a result, a connection of a certain user on an SNS can be intuitively recognized.

### Fifth Example Embodiment

When displaying information indicating a connection of a target user on an SNS by a method illustrated in FIG. 6, an information provision apparatus 10 according to the present example embodiment changes a display mode of a line R according to a relationship between activity areas of a user of an account relevant to two nodes P₁ and P₂ connected by the line R. A detailed description is given below.

One example of a functional block diagram of the information provision apparatus 10 according to the present example embodiment is illustrated in FIG. 7.

When displaying information indicating a connection of a target user on an SNS by the method illustrated in FIG. 6, the visualization unit 14 determines thickness of the line R connecting the two nodes P₁ and P₂ to be thickness according to a distance between activity areas of a user of an account relevant to the two nodes P₁ and P₂. For example, the closer a distance is, the thicker the line R may be. Thickness of the line R according to a distance may be determined by use of a sigmoid function, or thickness of the line R according to a distance may be determined by another method.

The visualization unit 14 may adopt a method of adjusting thickness of the line R in display illustrated in FIG. 6, may adopt a method of adjusting thickness of the line R in display (refer to FIGS. 8 and 9) according to the third example embodiment based on the method illustrated in FIG. 6, or may adopt a method of adjusting thickness of the line R in display (display on a map) according to the fourth example embodiment based on the method illustrated in FIG. 6.

As a modified example of the present example embodiment, a color of the line R may be changed according to a distance between activity areas of a user of an account relevant to the two nodes P₁ and P₂, a type of the line R (a solid line, a dotted line, or the like) may be changed, a shade of the line R may be changed, or a display form of the line R may be changed by another method.

Other components of the information provision apparatus 10 according to the present example embodiment are similar to those according to the first to fourth example embodiments.

The information provision apparatus 10 according to the present example embodiment achieves an advantageous effect similar to those according to the first and fourth example embodiment. Moreover, the information provision apparatus 10 according to the present example embodiment can intuitively recognize, based on a display mode of the line R, a distance between activity areas of a user. As a result, a connection of a certain user on an SNS can be intuitively recognized.

### Sixth Example Embodiment

The present example embodiment embodies transition of a screen displayed by a visualization unit 14 via an output apparatus included in an information provision apparatus 10 or a client terminal communicating with the information provision apparatus 10 (server). A detailed description is given below.

### First Example

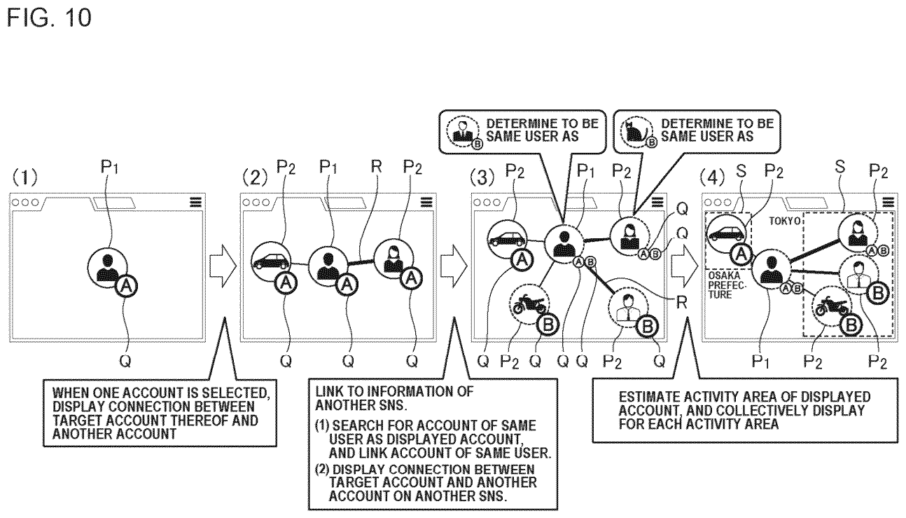

FIG. 10 illustrates one example of transition of a screen. First, the user performs an operation of specifying one account of one SNS. The operation may be an operation of performing a predetermined input from a menu screen, or may be another operation. Hereinafter, an SNS specified herein is referred to as a first SNS, and an account specified herein is referred to as a first account. In response to the operation, the visualization unit 14 displays a node P₁ relevant to the first account of the first SNS on a screen, as illustrated in FIG. 10(1).

Subsequently, the user performs an operation of displaying information indicating a connection between the first account and another account on the first SNS. The operation may be an operation of selecting the node P₁ displayed on, for example, the screen in FIG. 10(1), may be an operation of inputting a predetermined instruction after selecting the node P₁, may be an operation of performing a predetermined input from a menu screen, or may be another operation. In response to the operation, the visualization unit 14 displays node P₂ relevant to each account having a connection with the first account on the first SNS, and a line R connecting the node P₁ and the node P₂, as illustrated in FIG. 10(2).

Subsequently, the user performs an operation of further displaying information indicating a connection between an account other than the first account owned by the user of the first account, and another account. The operation may be an operation of selecting the node P₁ displayed on, for example, the screen in FIG. 10(2), may be an operation of inputting a predetermined instruction after selecting the node P₁, may be an operation of performing a predetermined input from a menu screen, or may be another operation. In response to the operation, the visualization unit 14 collectively displays a connection between each of a plurality of accounts owned by the user of the first account, and another account, as illustrated in FIG. 10(3). Note that, the display of FIG. 10(3) is the same as the display in FIG. 6 described in the second example embodiment.

Then, the user performs an operation of classifying and displaying a user of another account, based on an activity area. The operation may be an operation of performing a predetermined input from a menu screen, or may be another operation. In response to the operation, the visualization unit 14 groups a plurality of accounts, based on the activity area, and collectively displays the node P₂ for each group, as illustrated in FIG. 10(4). Note that, display in FIG. 10(4) is the same as the displays in FIGS. 8 and 9 described in the third example embodiment.

### Second Example

First, a user performs an operation of specifying one account of one SNS. The operation may be an operation of performing a predetermined input from a menu screen, or may be another operation. Hereinafter, an SNS specified herein is referred to as a first SNS, and an account specified herein is referred to as a first account. In response to the operation, the visualization unit 14 displays the node P₁ relevant to the first account of the first SNS on a screen, as illustrated in FIG. 10(1).

Thereafter, the user performs an operation of collectively displaying a connection between each of a plurality of accounts owned by the user of the first account, and another account, and classifying and displaying a user of anther account, based on an activity area. The operation may be an operation of selecting the node P₁ displayed on, for example, the screen in FIG. 10(1), may be an operation of inputting a predetermined instruction after selecting the node P₁, may be an operation of performing a predetermined input from a menu screen, or may be another operation.

The visualization unit 14 automatically transitions the screen in response to the operation. Specifically, the screen in FIG. 10(1) is determined to be a start, thereafter, the screen in FIG. 10(2) is displayed, thereafter, the screen in FIG. 10(3) is displayed, thereafter, the screen in FIG. 10(4) is displayed, and the transition ends with the screen in FIG. 10(4). A length of time of displaying the screens in FIGS. 10(2) and 10(3) is a matter of design.

### Third Example

First, a user performs an operation of specifying one account of one SNS. The operation may be an operation of performing a predetermined input from a menu screen, or may be another operation. Hereinafter, an SNS specified herein is referred to as a first SNS, and an account specified herein is referred to as a first account. In response to the operation, the visualization unit 14 displays the node P₁ relevant to the first account of the first SNS on the screen, as illustrated in FIG. 10(1).

Subsequently, the user performs “an operation of displaying information indicating a connection between the first account and another account on the first SNS”, “an operation of collectively displaying a connection between each of a plurality of accounts owned by the user of the first account and another account”, or “an operation of collectively displaying a connection between each of a plurality of accounts owned by the user of the first account and another account, and classifying and displaying a user of another account, based on an activity area”. The operation may be an operation of selecting the node P₁ displayed on, for example, the screen of FIG. 10(1), may be an operation of inputting a predetermined instruction after selecting the node P₁, may be an operation of performing a predetermined input from a menu screen, or may be another operation.

The visualization unit 14 displays a specified screen in response to the operation. For example, when “an operation of displaying information indicating a connection between the first account and another account on the first SNS” is performed, the visualization unit 14 transitions from the screen in FIG. 10(1) to the screen in FIG. 10(2), and ends the transition there.

Otherwise, when “an operation of collectively displaying a connection between each of a plurality of accounts owned by the user of the first account and another account” is performed, the visualization unit 14 transitions from the screen in FIG. 10(1) to the screen in FIG. 10(3), and ends the transition there.

Otherwise, the visualization unit 14 may transition from the screen in FIG. 10(1) to the screen in FIG. 10(2), thereafter, transition from the screen in FIG. 10(2) to the screen in FIG. 10(3), and end the transition there.

Otherwise, when “an operation of collectively displaying a connection between each of a plurality of accounts owned by the user of the first account and another account, and classifying and displaying a user of another account, based on an activity area” is performed, the visualization unit 14 transitions from the screen of FIG. 10(1) to the screen of FIG. 10(4), and ends the transition there. Otherwise, the visualization unit 14 may transition from the screen in FIG. 10(1) to the screen in FIG. 10(2), thereafter, transition from the screen in FIG. 10(2) to the screen in FIG. 10(3), thereafter, transition from the screen in FIG. 10(3) to the screen in FIG. 10(4), and end the transition there.

Note that, when a predetermined operation for the node P₂ relevant to an account of another user is accepted on a screen showing a connection of a target user on an SNS as described above, information indicating a connection of the user of the account relevant to the node P₂ on an SNS above may be further displayed. In this case, the connection of the target user on the SNS and the connection of the another user on the SNS are displayed simultaneously on one screen. Thus, the connection of the target user on the SNS and the connection of the another user on the SNS may be identifiably displayed by coloring or the like of the nodes P₁ and P₂ and the line R.

Other components of the information provision apparatus 10 according to the present example embodiment are similar to those according to the first to fifth example embodiments.

The information provision apparatus 10 according to the present example embodiment achieves an advantageous effect similar to those according to the first and fifth example embodiment. Moreover, the information provision apparatus 10 according to the present example embodiment can transition a screen showing a connection between a user and another user by various methods. As a result, a connection of a certain user on an SNS can be displayed the connection of a certain user on the SNS in a manner that is easy for the user to understand.

### Seventh Example Embodiment

An information provision apparatus 10 according to the present example embodiment can restrict public information to be referred to in processing described in the first to sixth example embodiments. Specifically, the information provision apparatus 10 accepts a user input specifying a period. Then, the information provision apparatus 10 performs processing described in the first to sixth example embodiments, based on public information published within a specified period. A detailed description is given below.

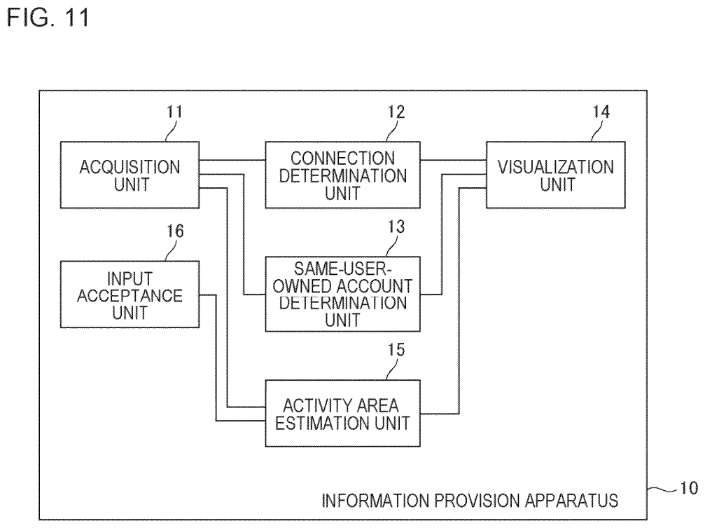

FIG. 11 illustrates one example of a functional block diagram of the information provision apparatus 10 according to the present example embodiment. As illustrated, the information provision apparatus 10 includes an acquisition unit 11, a connection determination unit 12, a same-user-owned account determination unit 13, a visualization unit 14, an activity area estimation unit 15, and an input acceptance unit 16.

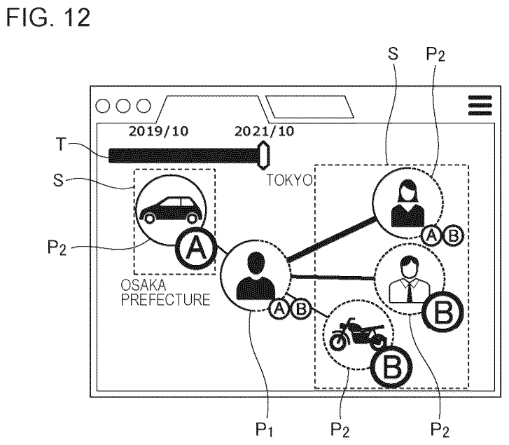

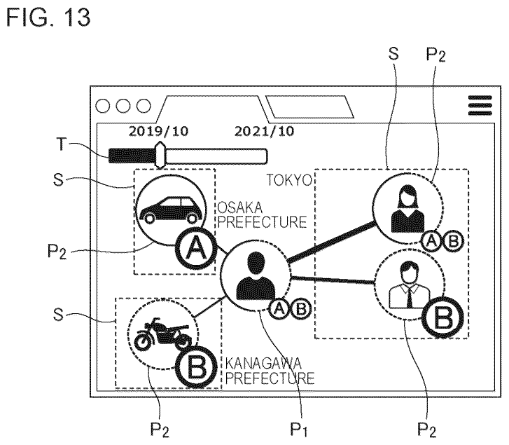

The input acceptance unit 16 accepts an input specifying a period. For example, the input acceptance unit 16 may display a user interface (UI) component T as illustrated in FIGS. 12 and 13, and accept a user input specifying a period via the UI component T. The illustrated UI component T is a slider, and it is possible to specify a period by sliding a position of a knob.

At least one of the connection determination unit 12 and the activity area estimation unit 15 performs processing described in the first to sixth example embodiments, based on public information published within a specified period. That is to say, at least one of the connection determination unit 12 and the activity area estimation unit 15 performs processing described in the first to sixth example embodiments without referring to public information published outside the specified period.

For example, the connection determination unit 12 may determine a connection between a plurality of accounts, based on public information published within a specified period. In this case, the visualization unit 14 displays, as information indicating a connection of a target user on an SNS, “a connection between an account owned by the user and another account” determined based on public information published within a specified period. When public information to be referred to is different, a result of a connection between a plurality of accounts to be determined may also be different.

Moreover, the activity area estimation unit 15 may estimate an activity area of a user of each account, based on public information published within a specified period. In this case, the visualization unit 14 performs display of screens as illustrated in FIGS. 8, 9 and 10(4), based on an activity area of a user of each account estimated based on public information published within a specified period. As illustrated in FIGS. 12 and 13, when public information to be referred to is different, a result of an estimated activity area may also be different.

Other components of the information provision apparatus 10 according to the present example embodiment are similar to those according to the first to sixth example embodiments.

The information provision apparatus 10 according to the present example embodiment achieves an advantageous effect similar to those according to the first and sixth example embodiment. Moreover, the information provision apparatus 10 according to the present example embodiment can restrict public information to be referred to, by a publication period. As a result, not only a state at a current time point but also a state at a past time point can be recognized as a connection of a certain user on an SNS, and state another transition can be recognized.

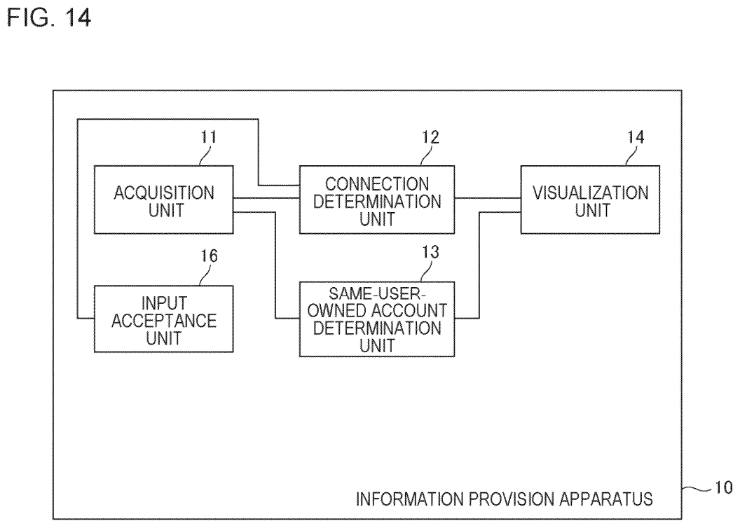

Herein, a modified example of the present example embodiment is described. FIG. 14 illustrates one example of a functional block diagram of an information provision apparatus 10 according to the modified example of the present example embodiment. As illustrated, the information provision apparatus 10 includes an acquisition unit 11, a connection determination unit 12, a same-user-owned account determination unit 13, a visualization unit 14, and an input acceptance unit 16. That is to say, the information provision apparatus 10 according to the modified example of the present example embodiment does not include an activity area estimation unit 15. Other components of the information provision apparatus 10 according to the modified example of the present example embodiment are similar to those of the information provision apparatus 10 according to the present example embodiment described above. The modified example also achieves an advantageous effect similar to that of the information provision apparatus 10 according to the present example embodiment.

### Eighth Example Embodiment

In addition to a unit according to the first to seventh example embodiments, the information provision apparatus 10 according to the present example embodiment can further determine, based on a user input, a plurality of accounts owned by the same user. A detailed description is given below.

The same-user-owned-account determination unit 13 includes a unit that determines a plurality of accounts owned by the same user, based on a user input, in addition to a unit (the unit according to the first to seventh example embodiments) that determines, based on public information, a plurality of accounts owned by the same user.

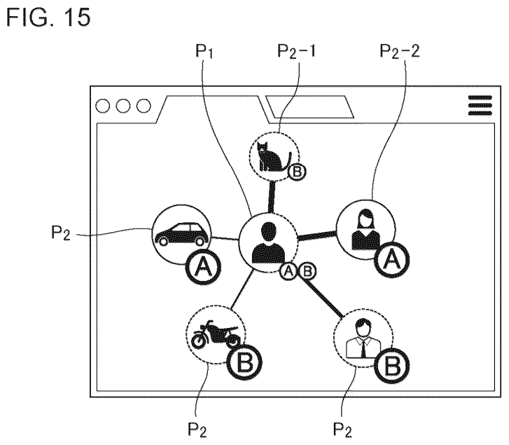

For example, the same-user-owned account determination unit 13 may accept a user input determining a plurality of accounts owned by the same user, on a screen showing a connection of a target user on an SNS as illustrated in FIG. 15. A user input determining a plurality of accounts owned by the same user may be an input that brings, for example, a plurality of nodes P₂ relevant to a plurality of accounts owned by the same user closer to each other (brings a mutual distance within a threshold value). For example, when a node P₂-1 and a node P₂-2 in FIG. 15 are relevant to an account owned by the same user, the user performs an input that brings the node P₂-1 and the node P₂-2 closer to each other. The input can be achieved by use of any technique such as drag and drop.

The visualization unit 14 performs processing described in the first to seventh example embodiments, based on a “determination result of a plurality of accounts owned by the same user” acquired by the method described above.

Other components of the information provision apparatus 10 according to the present example embodiment are similar to those according to the first to seventh example embodiments.

The information provision apparatus 10 according to the present example embodiment achieves an advantageous effect similar to those according to the first and seventh example embodiment. Moreover, the information provision apparatus 10 according to the present example embodiment can determine, by a user input, “a plurality of accounts owned by the same user” that have not been determined in public information. As a result, determination failure can be reduced.

The example embodiments according to the present invention have been described above with reference to the drawings, but are exemplifications of the present invention, and various configurations other than those described above can be adopted. The components according to the example embodiments described above may be combined with each other, or some of the components may be replaced with other components. Moreover, various modifications may be made to the components according to the above-described example embodiments without departing from the spirit thereof. Moreover, the components and processing disclosed in each of the above example embodiments and modified examples may be combined with each other.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.

1. An information provision apparatus including:
an acquisition unit that acquires public information associated with each of a plurality of accounts existing in each of a plurality of types of SNSes;
a connection determination unit that determines a connection between a plurality of the accounts, based on the public information;
a same-user-owned account determination unit that determines, based on the public information, a plurality of the accounts owned by a same user; and
a visualization unit that collectively displays, as information indicating a connection of a certain user on an SNS, a connection between each of a plurality of the accounts owned by the certain user and another of the accounts.
   2. The information provision apparatus according to supplementary note 1, wherein
the visualization unit
   displays a screen showing, as information indicating a connection of a certain user on an SNS, a node relevant to each of a plurality of the accounts, and a line connecting the nodes of accounts having a mutual connection, and
   displays, on the screen, one of the nodes relevantly to a plurality of the accounts owned by a same user.
      3. The information provision apparatus according to supplementary note 2, further including
an activity area estimation unit that estimates, based on the public information, an activity area of a user of the account, wherein
the visualization unit groups a plurality of the accounts, based on the activity area, and collectively displays the node for each group on the screen.
   4. The information provision apparatus according to supplementary note 2, further including
an activity area estimation unit that estimates, based on the public information, an activity area of a user of the account, wherein
the visualization unit displays the screen on which the node is displayed on a map, and the node is displayed at a position on a map relevant to the activity area.
   5. The information provision apparatus according to any one of supplementary notes 2 to 4, further including
an activity area estimation unit that estimates, based on the public information, an activity area of a user of the account, wherein
the visualization unit sets thickness of a line connecting the two nodes to thickness according to a distance between the activity areas of a user of the account.
   6. The information provision apparatus according to any one of supplementary notes 3 to 5, further including
an input acceptance unit that accepts an input specifying a period, wherein
the activity area estimation unit estimates the activity area of a user of the account, based on the public information published within the period, and
the visualization unit performs display of the screen, based on the activity area of a user of the account estimated based on the public information published within the period.
   7. The information provision apparatus according to any one of supplementary notes 1 to 6, further including
an input acceptance unit that accepts an input specifying a period, wherein
the connection determination unit determines a connection between a plurality of the accounts, based on the public information published within the period, and
the visualization unit displays, as information indicating a connection of a certain user on an SNS, a connection between the account owned by the certain user determined based on the public information published within the period, and another of the accounts.
   8. The information provision apparatus according to any one of supplementary notes 1 to 7, wherein
the visualization unit displays, in association with the node, a mark indicating an SNS in which one or a plurality of the accounts relevant to the node exist, and
a display mode of the mark changes according to utilization frequency of the SNS.
   9. An information provision method including,
by a computer executing:
   an acquisition step of acquiring public information associated with each of a plurality of accounts existing in each of a plurality of types of SNSes;
   a connection determination step of determining a connection between a plurality of the accounts, based on the public information;
   a same-user-owned account determination step of determining, based on the public information, a plurality of the accounts owned by a same user; and
   a visualization step of collectively displaying, as information indicating a connection of a certain user on an SNS, a connection between each of a plurality of the accounts owned by the certain user and another of the accounts.
      10. A program causing a computer to function as:
an acquisition unit that acquires public information associated with each of a plurality of accounts existing in each of a plurality of types of SNSes;
a connection determination unit that determines a connection between a plurality of the accounts, based on the public information;
a same-user-owned account determination unit that determines, based on the public information, a plurality of the accounts owned by a same user; and
a visualization unit that collectively displays, as information indicating a connection of a certain user on an SNS, a connection between each of a plurality of the accounts owned by the certain user and another of the accounts.

### REFERENCE SIGNS LIST

10 Information provision apparatus
11 Acquisition unit
12 Connection determination unit
13 Same-user-owned account determination unit
14 Visualization unit
15 Activity area estimation unit
16 Input acceptance unit
1A Processor
2A Memory
3A Input/output I/F
4A Peripheral circuit
5A Bus

What is claimed is:

1. An information provision apparatus comprising:
at least one memory configured to store one or more instructions; and
at least one processor configured to execute the one or more instructions to:
acquire public information associated with each of a plurality of accounts existing in each of a plurality of types of social networking services (SNSes);
determine a connection between a plurality of the accounts, based on the public information;
determine, based on the public information, a plurality of the accounts owned by a same user; and
collectively display, as information indicating a connection of a certain user on an SNS, a connection between each of a plurality of the accounts owned by the certain user and another of the accounts.

2. The information provision apparatus according to claim 1, wherein
the at least one processor is further configured to execute the one or more instructions to
display a screen showing, as information indicating a connection of a certain user on an SNS, a node relevant to each of a plurality of the accounts, and a line connecting the nodes of accounts having a mutual connection, and
display, on the screen, one of the nodes relevantly to a plurality of the accounts owned by a same user.

3. The information provision apparatus according to claim 2, wherein the at least one processor is further configured to execute the one or more instructions to
estimate, based on the public information, an activity area of a user of the account, and
group a plurality of the accounts, based on the activity area, and collectively display the node for each group on the screen.

4. The information provision apparatus according to claim 2, wherein the at least one processor is further configured to execute the one or more instructions to
estimate, based on the public information, an activity area of a user of the account, and
display the screen on which the node is displayed on a map, and the node is displayed at a position on a map relevant to the activity area.

5. The information provision apparatus according to claim 2, wherein the at least one processor is further configured to execute the one or more instructions to
estimate, based on the public information, an activity area of a user of the account, and
set thickness of a line connecting the two nodes to thickness according to a distance between the activity areas of a user of the account.

6. The information provision apparatus according to claim 3, wherein the at least one processor is further configured to execute the one or more instructions to
accept an input specifying a period,
estimate the activity area of a user of the account, based on the public information published within the period, and
perform display of the screen, based on the activity area of a user of the account estimated based on the public information published within the period.

7. The information provision apparatus according to claim 1, wherein the at least one processor is further configured to execute the one or more instructions to
accept an input specifying a period,
determine a connection between a plurality of the accounts, based on the public information published within the period, and
display, as information indicating a connection of a certain user on an SNS, a connection between the account owned by the certain user determined based on the public information published within the period, and another of the accounts.

8. The information provision apparatus according to claim 1, wherein the at least one processor is further configured to execute the one or more instructions to
display, in association with the node, a mark indicating an SNS in which one or a plurality of the accounts relevant to the node exist, and
a display mode of the mark changes according to utilization frequency of the SNS.

9. An information provision method comprising,
by a computer executing:
acquiring public information associated with each of a plurality of accounts existing in each of a plurality of types of SNSes;
determining a connection between a plurality of the accounts, based on the public information;
determining, based on the public information, a plurality of the accounts owned by a same user; and
collectively displaying, as information indicating a connection of a certain user on an SNS, a connection between each of a plurality of the accounts owned by the certain user and another of the accounts.

10. A non-transitory storage medium storing a program causing a computer to:
acquire public information associated with each of a plurality of accounts existing in each of a plurality of types of SNSes;
determine a connection between a plurality of the accounts, based on the public information;
determine, based on the public information, a plurality of the accounts owned by a same user; and
display, as information indicating a connection of a certain user on an SNS, a connection between each of a plurality of the accounts owned by the certain user and another of the accounts.

11. The information provision method according to claim 9, wherein
the computer
displays a screen showing, as information indicating a connection of a certain user on an SNS, a node relevant to each of a plurality of the accounts, and a line connecting the nodes of accounts having a mutual connection, and
displays, on the screen, one of the nodes relevantly to a plurality of the accounts owned by a same user.

12. The information provision method according to claim 11, wherein the computer
estimates, based on the public information, an activity area of a user of the account, and
groups a plurality of the accounts, based on the activity area, and collectively displays the node for each group on the screen.

13. The information provision method according to claim 11, wherein the computer
estimates, based on the public information, an activity area of a user of the account, and
displays the screen on which the node is displayed on a map, and the node is displayed at a position on a map relevant to the activity area.

14. The information provision method according to claim 11, wherein the computer
estimates, based on the public information, an activity area of a user of the account, and
sets thickness of a line connecting the two nodes to thickness according to a distance between the activity areas of a user of the account.

15. The information provision method according to claim 12, wherein the computer
accepts an input specifying a period,
estimates the activity area of a user of the account, based on the public information published within the period, and
performs display of the screen, based on the activity area of a user of the account estimated based on the public information published within the period.

16. The non-transitory storage medium according to claim 10, wherein the program causing the computer to
display a screen showing, as information indicating a connection of a certain user on an SNS, a node relevant to each of a plurality of the accounts, and a line connecting the nodes of accounts having a mutual connection, and
display, on the screen, one of the nodes relevantly to a plurality of the accounts owned by a same user.

17. The non-transitory storage medium according to claim 16, wherein the program causing the computer to
estimate, based on the public information, an activity area of a user of the account, and
group a plurality of the accounts, based on the activity area, and collectively display the node for each group on the screen.

18. The non-transitory storage medium according to claim 16, wherein the program causing the computer to
estimate, based on the public information, an activity area of a user of the account, and
display the screen on which the node is displayed on a map, and the node is displayed at a position on a map relevant to the activity area.

19. The non-transitory storage medium according to claim 16, wherein the program causing the computer to
estimate, based on the public information, an activity area of a user of the account, and
set thickness of a line connecting the two nodes to thickness according to a distance between the activity areas of a user of the account.

20. The non-transitory storage medium according to claim 17, wherein the program causing the computer to
accept an input specifying a period,
estimate the activity area of a user of the account, based on the public information published within the period, and
perform display of the screen, based on the activity area of a user of the account estimated based on the public information published within the period.
